(19) United States
(12) Patent Application Publication
(10) Pub. No.: US 2015/0209822 A1
(43) Pub. Date: Jul. 30, 2015

(54) INSERT FOR A PAINT BUCKET

(71) Applicant: STEVEN EDWARD ENGUITA, Fort Myers, FL (US)

(72) Inventor: STEVEN EDWARD ENGUITA, Fort Myers, FL (US)

(21) Appl. No.: 14/585,697

(22) Filed: Dec. 30, 2014

Related U.S. Application Data
(63) Continuation-in-part of application No. 13/647,464, filed on Oct. 9, 2012.

(51) Int. Cl. B05C 17/02; B44D 3/12

(52) U.S. Cl. CPC B05C 17/0245; B44D 3/126

(57) ABSTRACT

An insert is deployed in an applicable paint bucket to provide for rolling a paint roller along the insert to uniformly distribute a desired quantity of paint from the paint bucket onto the paint roller. Applicable paint bucket have structures which provide for a secure placement of the insert where the insert remains in a proper operational orientation during a painting session. The insert has a paint contact area with an upper portion thereof retained at an angular orientation somewhat offset from vertical when installed in the applicable paint bucket. In the preferred embodiment the insert has securement structures which extend outward on opposing sides of the paint contact area at the upper extent. The insert has means to vary the width of an upper securement portion wherein the insert will remain properly installed in the applicable paint bucket when a spacing of securement positions on the applicable paint bucket vary during use.

### CROSS-REFERENCE

This application is a continuation-in-part of Ser. No. 13/647,464 filed Oct. 9, 2012, entitled “insert for a paint bucket”, currently pending. The original application is incorporated herein by this reference.

### BACKGROUND

1. Field of the Invention

Generally, the invention relates to inserts having a surface for distributing paint on a paint roller. More specifically, the invention relates to such inserts capable of being relatively securely positioned in a paint bucket having means to retain the insert.

2. Description of the Prior Art

Various methods are known to apply paint to a wall surface. It may be mechanically sprayed on the wall surface without any paint retaining structure actually touching the wall surface. This method is not directly applicable to the present invention and will not be discussed further. Typically a paint retaining structural element will have paint placed on the paint retaining structural element with transfer of such paint occurring by wiping or rolling the paint retaining structural element on the wall surface. The two most common painting tools having applicable paint retaining structural elements are the paint brush and the paint roller. The present invention may be utilized with paint brushes to significantly enhance the painting experience during use of the paint brush. The present invention is generally related to use of the paint roller. Paint rollers have a cylindrical portion with a paint retaining surface, such as a mat material, rotationally mounted to a manipulation part, typically in the form of a handle. Most modern paint roller handles have means to attach a long extension handle thereto, such as a female threaded cavity in the end of the handle to receive threads on a male end of the long extension handle. During use paint is gathered on the paint retaining surface of the cylindrical portion to a desired uniformity and density and then the paint retaining surface is rolled along the wall surface to transfer the paint to the wall surface.

The rolling surface of inserts having features of the present invention preferably will be of sufficient width to operate with conventional paint rollers. Paint rolling surfaces conventionally known typically are of such width. It being understood that all such existing prior art structures having rolling surfaces, as well as the present invention, can be used with hand held paint brushes where excess paint is removed from the brush during painting. The following general description of known rolling surfaces, and how and where they are deployed, will focus on such rolling surfaces of a width sufficient to accommodate a standard width paint roller.

Painters of wall surfaces who use paint rollers have personal preferences for painting equipment utilized during their respective painting. Generally, painters who utilize a paint roller roll the roller across the surface of the fresh paint, and then roll the roller over a rolling surface to uniformly distribute the paint onto the roller while removing any excess paint from the roller. The following description depicts several known arrangements of a paint containment area and an associated paint rolling surface area for paint rollers. It is universally accepted that the paint rolling surface area permit the paint to drain back into the paint containment area subsequent to the paint roller being rolled over the paint rolling surface area.

The two most common methods of containment of the paint with the most common method of providing a rolling surface near the contained paint are used during this description.

The first method is use of a bulk paint container, such as a round five gallon bulk paint bucket, with an assembly with a rolling surface which hangs inside the bulk container from the lip. This method is popular with commercial painters. With this method the painter works directly from the round bulk paint container with the rolling surface standing vertically, or nearing vertical, inside the bulk container. In order to utilize the assembly with the rolling surface in such a bulk container the bulk container must contain well less than the containment capacity of paint where a large portion of the assembly is above the level of the paint. In use the paint roller will be placed in contact with the paint and then rolled along the rolling surface of the hanging assembly to generally uniformly distribute the paint on the roller. This arrangement, while widely utilized by painters, has several drawbacks. The opening to such bulk containers are not much wider than the roller assembly being inserted into the bulk container. This limits the displacement of the paint roller over the surface of the paint where fresh paint may be gathered by a greater surface area of the paint roller as the paint roller rotates. This becomes even more of a problem as the level of paint in the bulk container drops as such round bulk containers always narrow slightly when going toward the base. Additionally, the confined opening and the limited space within the bulk container, especially when considering the presence of the hanging assembly, causes several problems. Occasionally the painter will inadvertently bring the paint roller into contact with the lip of the bulk container while attempting to place the paint roller into the bulk container to replenish the supply of paint on their paint roller. When this unintended contact occurs some of the paint remaining on the paint roller will be transferred to the lip and sides, interior and exterior, of the bulk container. This occasionally results in paint be deposited on the floor or more often on the protective coverings placed on the floor during the painting. Even when all of the paint on the lip and the exterior wall remain on the bulk container it makes it difficult to handle the bulk container during the painting session and during the cleanup procedure. Another problem relates to the limited sight ability of the painter into the bulk container to fully observe their paint replenishing operation. This makes it difficult to be consistent during the fresh paint gathering operation, to gather the desired quantity of fresh paint, and during the rolling operation, to uniformly distribute the paint on the paint roller. Yet another problem is the limited angular orientation range that the hanging paint rolling surface may be placed in due to space limitations. Often the paint rolling surface will be positioned at a generally vertical orientation which is not a convenient angular orientation for most painters to use. Even when angularly offset from vertical the greatest angular offset possible is insufficient to provide for comfortable use. In order to provide some offset from vertical it is known in the art to have the lower extent of the hanging assembly structurally retained to be slightly away from the curved interior wall of the bulk container that it is resting against. This orientation unfortunately makes it more likely that the painter will inadvertently contact the hanging assembly with some portion of the paint roller subsequent to gather fresh paint below the hanging assembly. Such contact has been known to displace the hanging assembly, including complete removal from the bulk container. Such contact also has been known to cause a tipping of the bulk container, including to the point where paint is spilled from the bulk container.

The second method is use of a paint roller pan with an upward sloped rolling surface extending from a deeper paint containment end. Typically these paint roller pans contain no more than a gallon of paint at a time and are rectangular in shape, with slightly rounded corners, when viewed from above. Such paint roller pans will often have structures thereon to position the pan in a stable and secure manner on a ladder at an elevated position above the floor. This ladder placement method permits the painter to stand on the ladder during painting. This orientation is more often used with a handheld paint brush than with a paint roller. When a paint roller pan is used with a paint roller with long handle assembly, the paint roller pan will often rest on the floor adjacent the wall surface being painted. This method places the paint rolling surface at an angular orientation which is slightly offset from horizontal. Many painters find this angular orientation less desirable than one of similar offset from vertical. This method also typically has the paint rolling surface built into the pan. This make for a more difficult cleanup operation than desired. This also provides only the texture of the deployed paint rolling surface. This eliminates selection of other surface textures for the rolling surface where some alternative surface texture might be superior depending upon other factors involved with the painting session. This method typically has a fairly shallow pan with only a few inches of wall surrounding the surface of the paint when the pan is filled to the maximum intended level. This often results in sloshing of paint over the surrounding wall and onto the floor or the protective covering placed on the floor when attempting to replenish the paint supply on the paint roller prior to engaging in the rolling operation to generally uniformly distribute the paint on the paint roller.

As can be seen each of these methods suffer from various deficiencies. There remains a need for an insert for paint buckets where the insert has a paint contact area for rolling of a paint roller thereon to uniformly distribute paint on the paint roller while the paint contact area of the insert is securely retained in a proper angular orientation for comfortable use. The present invention substantially fulfills these needs.

### SUMMARY

In view of the foregoing disadvantages inherent in the known methods of providing a rolling surface, positioned relative to a paint container, to roll a paint roller against to uniformly distribute paint on the paint roller, your applicant has devised an insert capable of being relatively securely positioned relative to a paint container.

The insert is for deployment in a paint bucket to provide for rolling a paint roller along the insert to uniformly distribute a desired quantity of paint from the paint bucket onto the paint roller. Applicable paint bucket have a paint containment area having an upper extent and a lower extent. The applicable paint bucket will have opposing anchoring portions to secure the insert against any foreseeable displacement except deliberate removal of the insert. The insert has a paint roller contact area having a width and a height. The width of the paint roller contact area has opposing side edges while the height of the paint roller contact area extends substantially along the opposing side edges of the width of the paint roller contact area and has an upper extent and a lower extent. The paint roller contact area is oriented in the applicable paint bucket, when installed, with the lower extent of the height inside the paint containment area of the applicable paint bucket and the upper extent of the height at the upper extent of the paint containment area of the paint bucket. The paint roller contact area is for rolling the paint roller along the height of the paint roller contact area to distribute a desired quantity of paint from the applicable paint bucket onto the paint roller. The insert also has an upper extent portion which extends across the upper extent of the height of the paint roller contact area and beyond the width of the paint roller contact area on the opposing side edges of the width of the paint roller contact area. The portions of the upper extent which extend beyond the width of the paint roller contact area on the opposing side edges of the width of the paint contact area provide for engagement of the opposing anchoring portions of the applicable paint bucket to secure the insert relative to the paint bucket. The portions of the upper extent which extend beyond the width of the paint roller contact area on the opposing side edges of the width of the paint contact area have adjustment features to provide for varying the spacing of the ends of the portions of the upper extent.

My invention resides not in any one of these features per se, but rather in the particular combinations of them herein disclosed and it is distinguished from the prior art in these particular combinations of these structures for the functions specified.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore a primary object of the present invention to provide for an insert which can easily be installed in applicable paint buckets to provide a paint contact area to roll a paint roller against to properly distribute fresh paint onto the paint roller.

Other objects include;

a) to provide for an adjustable feature of extending portions where securement in a workpiece paint bucket will occur during slight deforming of walls of the workpiece paint bucket which occur depending upon an amount of paint contained in the workpiece paint bucket.

b) to provide for the insert to be removable from the applicable paint bucket where the insert can be properly cleaned to remove all paint therefrom during a clean up procedure following a painting session.

c) to provide for the insert to be relatively securely retained on the applicable paint bucket where it remains in a proper operational orientation during the entire painting session.

d) to provide for the insert to be retained at an operational angular orientation on the applicable paint bucket where the painter may perform a fresh paint gathering operation and a rolling of the paint roller on the insert to uniformly distribute the fresh paint on the paint roller while the painter stands up straight in a comfortable stance.

e) to provide for the insert to be secured at both opposing upper securement locations and at a lower securement location where the insert cannot inadvertently be displaced from the operational location during the painting procedure.

f) to provide for the insert to have the paint contact area where the paint roller is rolled to be formed of a wire mesh material having a plurality of passageways therethrough to provide a superior paint distribution operation on the paint roller.

g) to provide for the insert to be extremely inexpensive where it is economically feasible to utilize a new insert for each painting session.

h) to provide for the insert to have a modest angular change near a lower extent of the insert where the lower extent of the paint contact area is retained generally vertical in applicable paint buckets while the upper portion is angled away from a paint access area at a comfortable angle.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated the preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein;

FIG. 1 is a perspective view of an insert for a paint bucket without the slidable caps installed.

FIG. 2 is a perspective view of a frame for the insert.

FIG. 3 is a side elevational view of the insert shown in FIG. 1.

FIG. 4 is a front elevational view of a sheet material.

FIG. 5 is a perspective view of the sheet material shown in FIG. 4.

FIG. 6 is a perspective view of a paint bucket which may utilize the insert shown in FIG. 1.

FIG. 7 is a top plan view of the paint bucket shown in FIG. 6.

FIG. 8 is a side elevational view of the paint bucket depicted in FIG. 6 with the insert, portions of a workpiece paint roller assembly and select portions of the paint bucket depicted with dashed ‘hidden lines’ to depict placement and orientation of various components.

FIG. 9 is an elevational view of a workpiece paint roller and labeled as ‘Prior Art’.

FIG. 10 is a front elevational view of a slidable cap.

FIG. 11 a side elevational view of the slidable cap shown in FIG. 10.

FIG. 12 is a perspective view of an insert for a paint bucket with the slidable caps installed and positioned at a first spacing.

FIG. 13 is a perspective view of the insert shown in FIG. 12 with the slidable caps installed and positioned at a second spacing.

### DESCRIPTION

Many different devices having features of the present invention are possible. The following description describes the preferred embodiment of select features of those devices and various combinations thereof. These features may be deployed in various combinations to arrive at various desired working configurations of devices.

Reference is hereafter made to the drawings where like reference numerals refer to like parts throughout the various views.

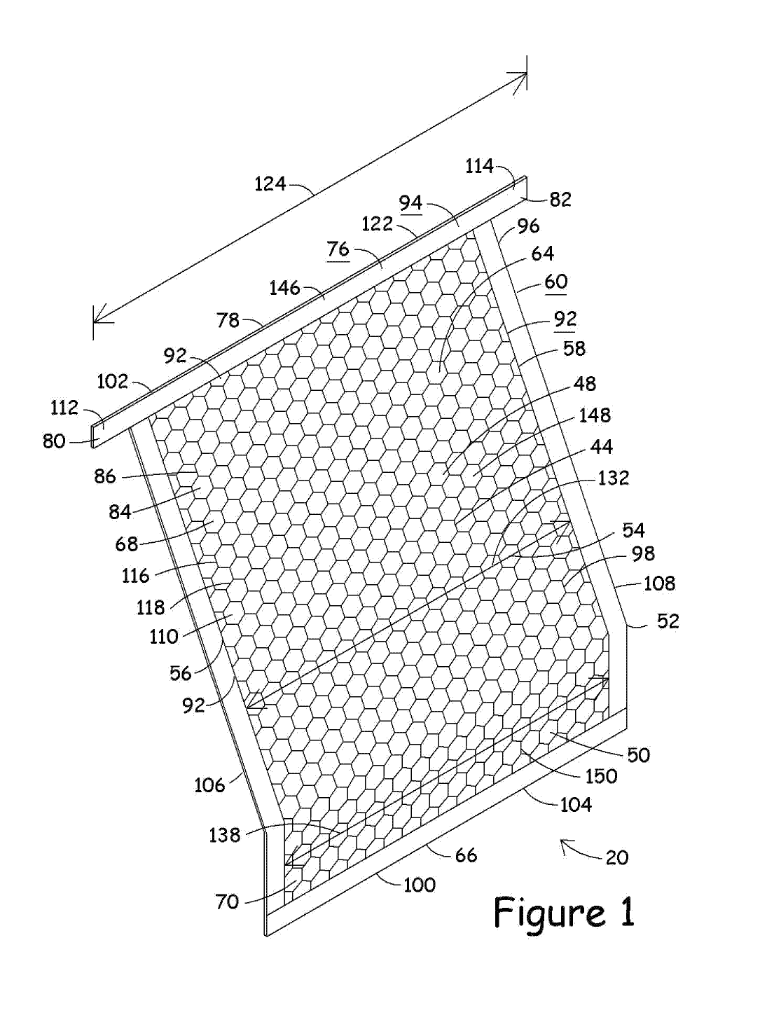

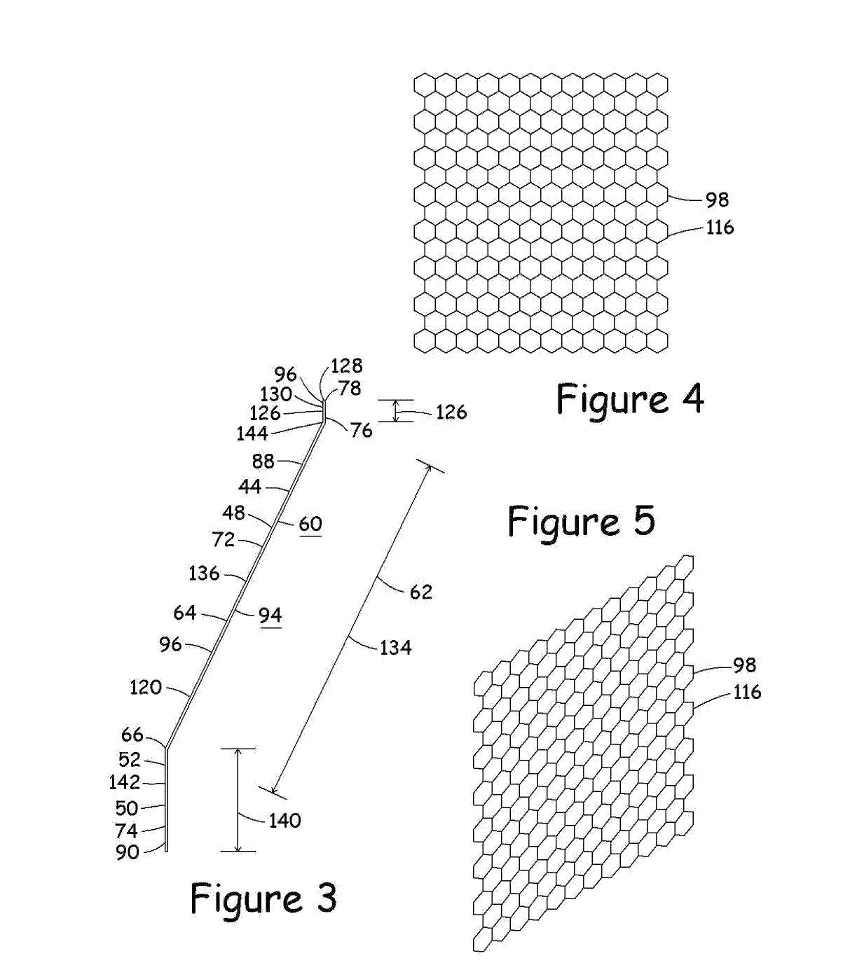

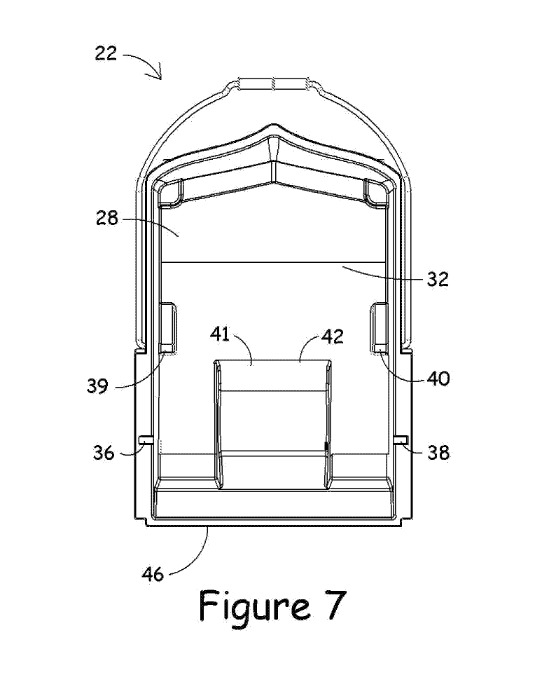

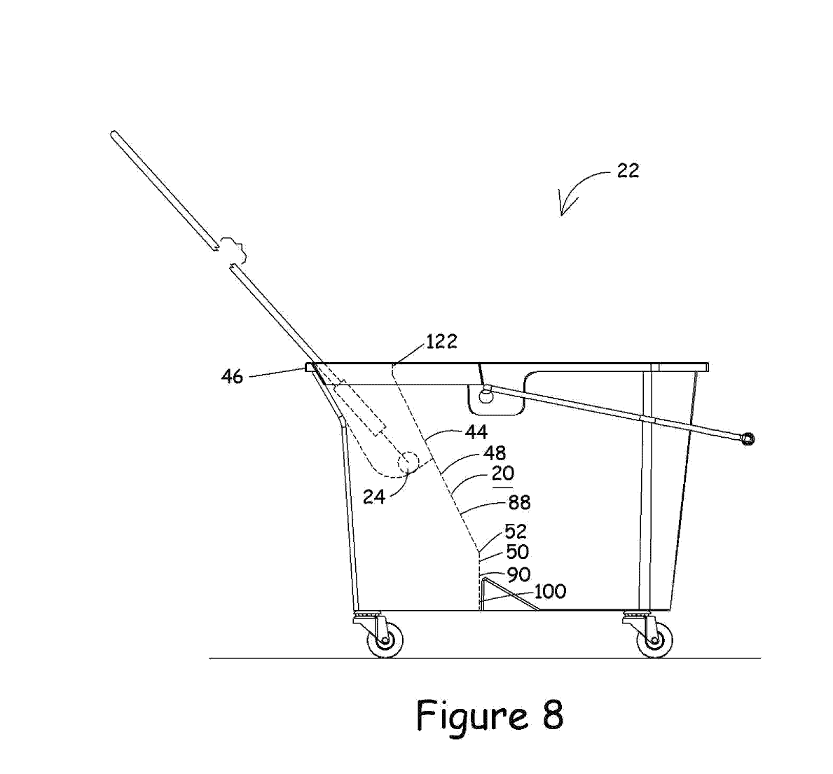

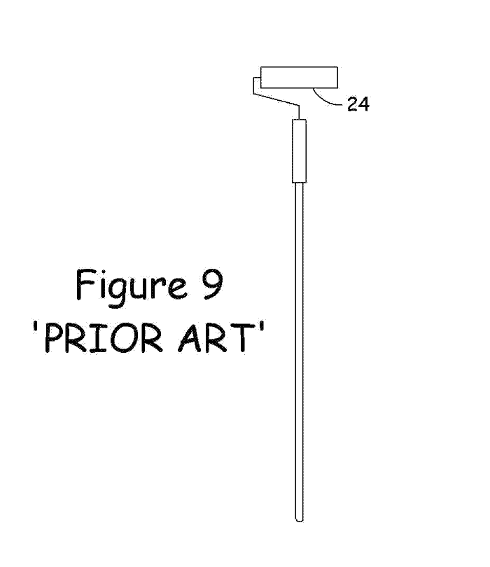

An insert 20, shown in FIG. 1, FIG. 3 and FIG. 8, is for deployment in a workpiece paint bucket 22, shown in FIG. 6, FIG. 7 and FIG. 8. Once deployed in workpiece paint bucket 22 insert 20 provides for rolling of a workpiece paint roller 24, shown in FIG. 8 and FIG. 9, along insert 20 to generally uniformly distribute workpiece paint 26, shown in FIG. 6, previously gathered from workpiece paint bucket 22 onto workpiece paint roller 24.

The present invention operates with various workpieces during use. Workpiece paint bucket 22, workpiece paint roller 24 and workpiece paint 26 are the most common of these workpieces. Workpiece paint roller 24 and workpiece paint 26 are prior art items well known. Workpiece paint bucket 22 depicted is an invention of the applicant and is subject to a separate Patent application filed at the time of filing of the present invention.

Workpiece paint roller 24 provides for a rolling of workpiece paint roller 24 along the insert having features of the present invention to generally uniformly distribute workpiece paint 26 previously gathered from workpiece paint bucket 22 onto workpiece paint roller 24.

Applicable workpiece paint bucket 22 will have a paint containment area 28, shown in FIG. 6 and FIG. 7, having an upper extent 30, shown in FIG. 6, a lower extent 32, shown in FIG. 7, and a high operational paint capacity level 34, shown in FIG. 6. High operational paint capacity level 34 is a level to which workpiece paint 26 is routinely placed in workpiece paint bucket 22. Workpiece paint bucket 22 will have opposing anchoring portions 36 and 38, both shown in FIG. 6 and FIG. 7, opposing lower anchoring portion 39 and 40, both shown in FIG. 7, and a center lower anchoring portion 41, shown in FIG. 7. Lower anchoring portion 40 is positioned generally at lower extent 32 of paint containment area 28. Workpiece paint bucket 22 preferably will have an insert contact surface 42, shown in FIG. 7, positioned generally within paint containment area 28. Insert contact surface 42 acts to engage at least a substantial portion of a paint roller contact area 44, shown in FIG. 1, FIG. 3 and FIG. 8, of insert 20 during deployment of insert 20 in workpiece paint bucket 22. This contact provides for pressure bearing support during rolling of workpiece paint roller 24 along insert 20 to distribute desired a quantity of workpiece paint 26 from workpiece paint bucket 22 onto workpiece paint roller 24. This acts to prevent inadvertent damage to insert 20 from occurring during usage. Workpiece paint bucket 22 has a user accessible end 46, shown in FIG. 6, FIG. 7 and FIG. 8, where the user, not shown in any of the views, would routinely stand during use of workpiece paint bucket 22.

Paint roller contact area 44, in certain embodiments, will be formed of a primary portion 48, shown in FIG. 1 and FIG. 3, and an auxiliary portion 50, shown in FIG. 1 and FIG. 3, having some readily identifiable configuration distinction therebetween. Such configuration distinction preferably will involve some deployed angular orientation distinction. Primary portion 48 and auxiliary portion 50 of paint roller contact area 44 preferably will each be at least substantially planar although a curvature of either or both portions is envisioned. In the most preferred embodiment shown in the drawings, primary portion 48 and auxiliary portion 50 are both substantially planar with a transition portion 52, shown in FIG. 1 and FIG. 3, therebetween. Transition portion 52, depending upon the material utilized and construction method utilized can be a short linear juncture or a bending of a common material, as depicted, which substantially forms both primary portion 48 and auxiliary portion 50.

Paint roller contact area 44 provides for rolling of workpiece paint roller 24 therealong to distribute a desired quantity of workpiece paint 26 from workpiece paint bucket 22 onto workpiece paint roller 24.

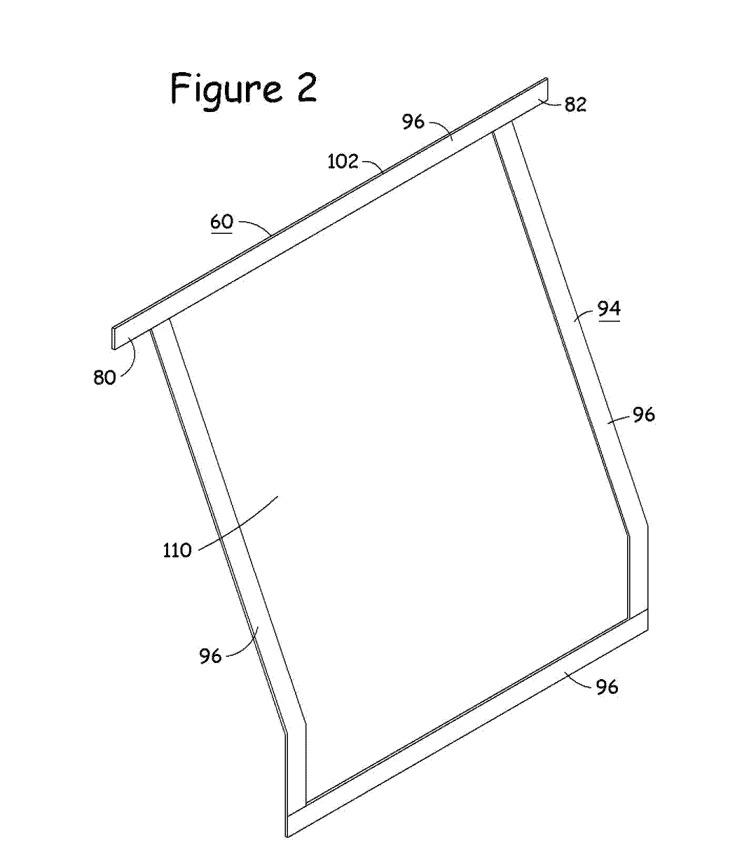

Paint roller contact area 44 will have a width 54, shown in FIG. 1, defined by opposing side edges 56 and 58, both shown in FIG. 1. Paint roller contact area 44 may have a frame assembly 60, shown in FIG. 1, FIG. 2 and FIG. 3, as depicted in the views, at least partially surrounding paint roller contact area 44. In certain embodiments paint roller contact area will extend complete to the opposing side edges.

Paint roller contact area 44 will have a height 62, shown in FIG. 3, extending substantially along opposing side edges 56 and 58 of width 54 of paint roller contact area 44. In certain embodiments paint roller contact area will only include areas corresponding to those depicted as primary portion 48 and will exclude auxiliary portion 50. In those instances the height of those embodiments will not be inclusive of both primary portion 48 and auxiliary portion 50.

Primary portion 48, in certain embodiments, will be the entire intended paint roller contact area 64, shown in FIG. 1 and FIG. 3. In these instances auxiliary portion 50 will preferably be available to contact workpiece paint roller 24 if rolled beyond lower extent 66, shown in FIG. 1 and FIG. 3, of paint roller contact area 64. In these instances, during routine use, workpiece paint roller 24 will ideally only be rolled along paint roller contact area 64 and not along auxiliary portion 50.

Primary portion 48 will have a dimensional size 68, shown in FIG. 1, while auxiliary portion 50 will have a dimensional size 70, shown in FIG. 1. Dimensional size 68 of primary portion 48 preferably is significantly greater than dimensional size 70 of auxiliary portion 50.

Primary portion 48 of paint roller contact area 44 resides generally on a single plane 72, shown in FIG. 3, while auxiliary portion 50 of paint roller contact area 44 resides generally on a single plane 74, shown in FIG. 3. Preferably plane 72 of primary portion 48 of paint roller contact area 44 is substantially offset from plane 74 of auxiliary portion 50 of paint roller contact area 44.

When insert 20 is deployed in workpiece paint bucket 22 primary portion 48 is positioned above auxiliary portion 50. When insert 20 is deployed in workpiece paint bucket 22 preferably at least a substantial portion of auxiliary portion 50 will be at least substantially elevationally below high operational paint capacity level 34 of paint containment area 28. Similarly, preferably at least a substantial portion of primary portion 48 will be at least substantially elevationally above high operational paint capacity level 34 of paint containment area 28. This will provide for primary portion 48 to be used for rolling of workpiece paint roller 24 without inadvertently reapplying workpiece paint 26 thereon from paint containment area 28.

In certain preferred embodiments, insert 20 will have an extending portion 76, shown in FIG. 1, to provide for engagement of structures on workpiece paint bucket 22 to secure insert 20 relative to workpiece paint bucket 22. In the embodiment depicted extending portion 76 extends completely across an upper extent 78, shown in FIG. 1 and FIG. 3, of insert 20 with opposing ends 80 and 82, both shown in FIG. 1 and FIG. 2, extending beyond width 54 of paint roller contact area 44 on opposing side edges 56 and 58 of paint roller contact area 44. Opposing ends 80 and 82 of extending portion 76 provide for engagement of opposing anchoring portions 36 and 38 respectively of workpiece paint bucket 22 to secure insert 20 relative to workpiece paint bucket 22.

While inserts having features of the present invention can have paint roller contact areas which are a solid material with some applicable texture or surface configuration thereon or may have a plurality of passageways therethrough. As depicted it is preferred to have a plurality of passageways 84, shown in FIG. 1, through paint roller contact area 44. This provides for drainage of workpiece paint 26 during usage to more rapidly and consistently distribute a desired uniformity of workpiece paint 26 onto workpiece paint roller 24. Applicable passageways may have nearly any desired shape or configuration, it is preferred to have each passageway 84 have a hexagon shape with a six sided perimeter 86, shown in FIG. 1. Conventionally available commercial paint roller assemblies typically have a parallelogram shape with a four sided perimeter with each of the opposite sets of sides being parallel and equal in length. The depicted use of hexagon shaped passageways 84 ensures ready identification of inserts having features of the present invention from conventionally available commercial paint roller assemblies having the four sided diamond shaped passageways.

As depicted primary portion 48 of paint roller contact area 44 preferably has an angular orientation 88, shown in FIG. 3 and FIG. 8, in workpiece paint bucket 22 when insert 20 is deployed where angular orientation 88 is significantly offset from vertical. This arrangement provides for the user to use the insert in applicable workpiece paint buckets while standing in a comfortable stance while affording adequate line of sight to observe the workpiece paint gathering procedure. Similarly auxiliary portion 50 of paint roller contact area 44 has an angular orientation 90, shown in FIG. 3 and FIG. 8, in workpiece paint bucket 22 when insert 20 is deployed which is substantially vertical.

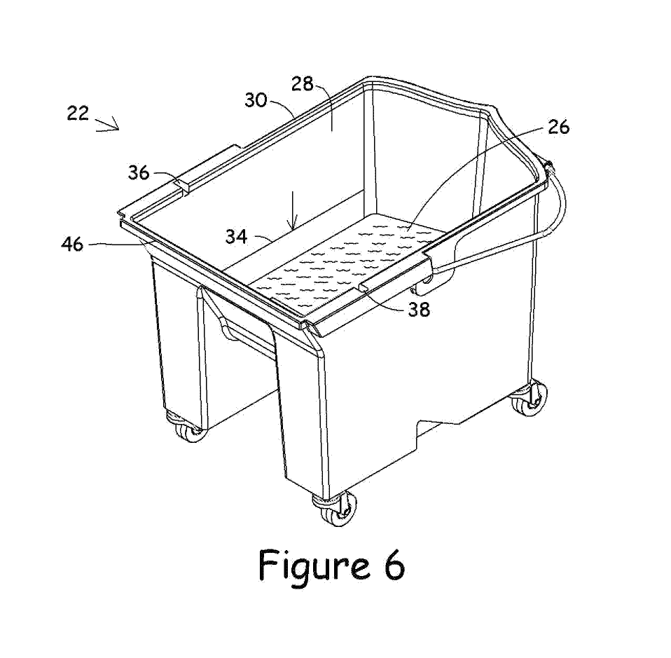

Paint roller contact area 44 has a surrounding perimeter 92, shown in FIG. 1. A frame portion 94, shown in FIG. 1, FIG. 2 and FIG. 3, extends at least substantially around surrounding perimeter 92 of paint roller contact area 44. Frame portion 94 is formed of a frame material 96, shown in FIG. 1, FIG. 2 and FIG. 3, folded over to engage and secure a sheet material 98, shown in FIG. 1, FIG. 4 and FIG. 5, forming paint roller contact area 44 to provide for a strengthening of the structural integrity of insert 20.

As previously disclosed, workpiece paint bucket 22 has lower anchoring portion 40 positioned generally at lower extent 32 of paint containment area 28. Insert 20 has lower securement means, in the form preferred form of a lower extent 100, shown in FIG. 1 and FIG. 8, to provide for engagement of lower anchoring portion 40 of workpiece paint bucket 22 to secure insert 20 relative to workpiece paint bucket 22.

Insert contact surface 42 of workpiece paint bucket 22 engages at least a substantial portion of paint roller contact area 44 of insert 20 during deployment of insert 20. This engagement provides for pressure bearing support during rolling of workpiece paint roller 24 along insert 20 to distribute the desired quantity of workpiece paint 26 from workpiece paint bucket 22 onto workpiece paint roller 24. This support acts to prevent inadvertent damage to insert 20 from occurring during rolling of workpiece paint roller 24 thereon.

As mentioned elsewhere herein inserts having features of the present invention can be formed from various materials utilizing various manufacturing methods. A preferred embodiment is depicted where insert 20 is formed of sheet material 98 and frame assembly 60. Sheet material 98 substantially forms paint roller contact area 44 while frame assembly 60 provides the desired rigidity and durability to insert 20.

Frame assembly 60 has an upper extent 102, shown in FIG. 1 and FIG. 2, a lower extent 104, shown in FIG. 1, and opposing side extents 106 and 108, both shown in FIG. 1. Frame assembly 60 substantially defines a confined area 110, shown in FIG. 1 and FIG. 2. Frame assembly 60 further has opposing protruding extensions 112 and 114, both shown in FIG. 1, as part of upper extent 102 with each protruding extension 112 and 114 extending beyond a respective opposing side extent 106 and 108 of frame assembly 60. Protruding extensions 112 and 114 provide for engagement of opposing anchoring portions 36 and 38 of workpiece paint bucket 22 to secure insert 20 relative to workpiece paint bucket 22.

Upper extent 102, lower extent 104 and opposing side extents 106 and 108 can be individual pieces of material, as depicted, or select extents can be formed from a single piece of material. Some form of securement means will provide for securing sheet material 98 within confined area 110.

Paint roller contact area 44 is substantially formed from sheet material 98 within confined area 110 of frame assembly 60 and secured therein by securement means of frame assembly, in this embodiment a bend and compression retention method.

Sheet material 98 forming paint roller contact area 44 is preferably formed of a wire mesh material 116, shown in FIG. 1, FIG. 4 and FIG. 5, with a plurality of passageways 84 therethrough. Each passageway 84 is bordered by perimeter 86 having defined edges 118, shown in FIG. 1, with each edge 118 of perimeter 86 of each passageway 84 angularly offset from vertical and from horizontal following deployment of insert 20 in workpiece paint bucket 22.

Frame assembly 60 is constructed from a planar material 120, shown in FIG. 3, having a longitudinal length and a bending and a folding of planar material 120 along the longitudinal length. This provides for frame assembly 60 to retain sheet material 98 forming paint roller contact area 44 utilizing a pressure bearing pinching contact.

In the embodiment depicted insert 20 can be further defined as having an upper portion 122, shown in FIG. 1 and FIG. 8, paint roller contact area 64 and auxiliary portion 50. Upper portion 122 has a length 124, shown in FIG. 1, a width 126, shown in FIG. 3, and a thickness 128, shown in FIG. 3, with length 124 significantly greater than width 126 and with width 126 significantly greater than thickness 128. Upper portion 122 also has an orientation plane 130, shown in FIG. 3, extending at least substantially along length 124 and width 126.

Paint roller contact area 64 is positioned below upper portion 122 when insert 20 is deployed in workpiece paint bucket 22. Paint roller contact area 64 has a width 132, shown in FIG. 1, a height 134, shown in FIG. 3, and an orientation plane 136, shown in FIG. 3, extending at least substantially along width 132 and height 134.

Auxiliary portion 50 is positioned below paint roller contact area 64 when insert 20 is deployed in workpiece paint bucket 22. Auxiliary portion 50 has a width 138, shown in FIG. 1, a height 140, shown in FIG. 3, and an orientation plane 142, shown in FIG. 3, extending at least substantially along width 138 and height 140.

Orientation plane 130 of upper portion 122 is generally parallel to and offset from orientation plane 142 of auxiliary portion 50. Orientation plane 136 of paint roller contact area 64 is substantially offset relative to both orientation plane 130 of upper portion 122 and orientation plane 142 of auxiliary portion 50.

Paint roller contact area 64 of insert 20 has an upper extent 144, shown in FIG. 3, and lower extent 66 when insert 20 is deployed in workpiece paint bucket 22. Orientation plane 136 of paint roller contact area 64 is significantly offset relative to vertical when insert 20 is deployed in workpiece paint bucket 22 where orientation plane 136 of paint roller contact area 64 is sloped toward user accessible end 46 from lower extent 66 to upper extent 144 when insert 20 is deployed in workpiece paint bucket 22.

Upper portion 122 has an area 146, shown in FIG. 1, and paint roller contact portion 44 has an area 148 and auxiliary portion 50 has an area 150, shown in FIG. 1. Area 150 of auxiliary portion 50 is substantially greater than area 146 of upper portion 122. Area 148 of paint roller contact area 64 is substantially greater than area 150 of auxiliary portion 50.

It is envisioned that the workpiece paint containment area of the workpiece paint bucket may have an area to receive workpiece paint to the high operational paint capacity level with surrounding walls of an elevational height sufficient to contain the workpiece paint and an elevationally higher portion extending above those walls and having means to retain the insert where the insert can perform the intended function of the insert. In such embodiments the workpiece paint containment area provides for containment of workpiece paint both to the high operational paint capacity level and during interaction with the insert and drainage of excess workpiece paint from the insert at a much higher elevational level than the high operational paint capacity level.

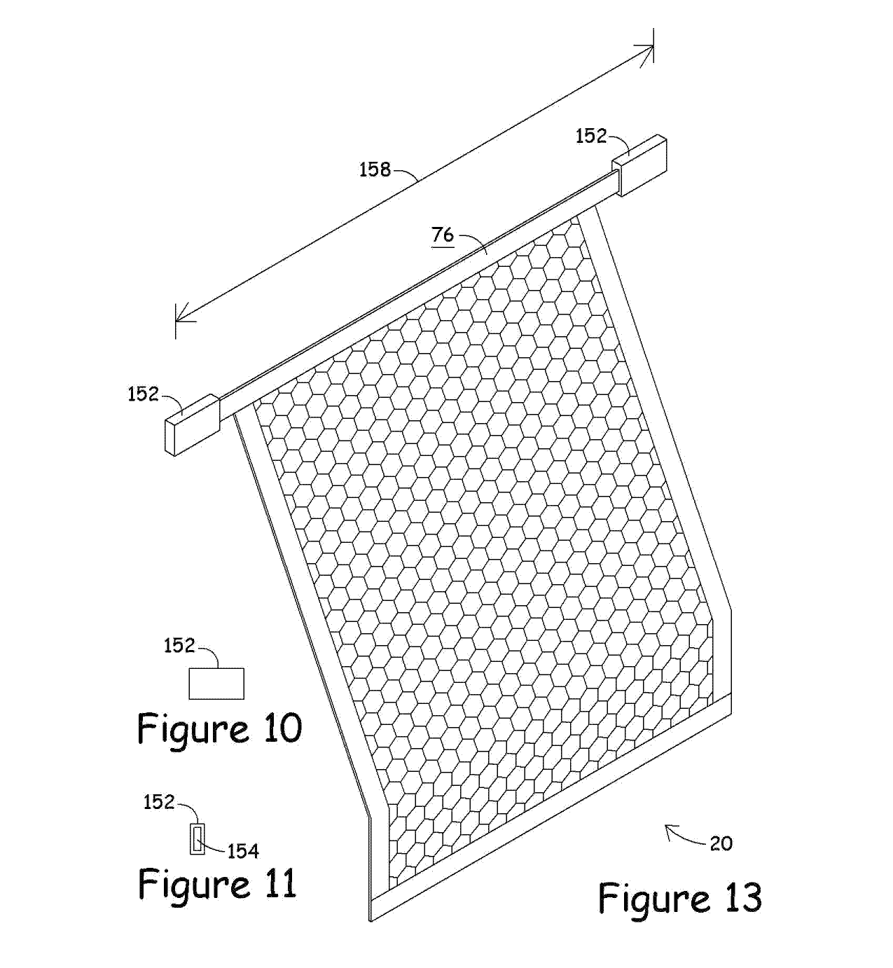

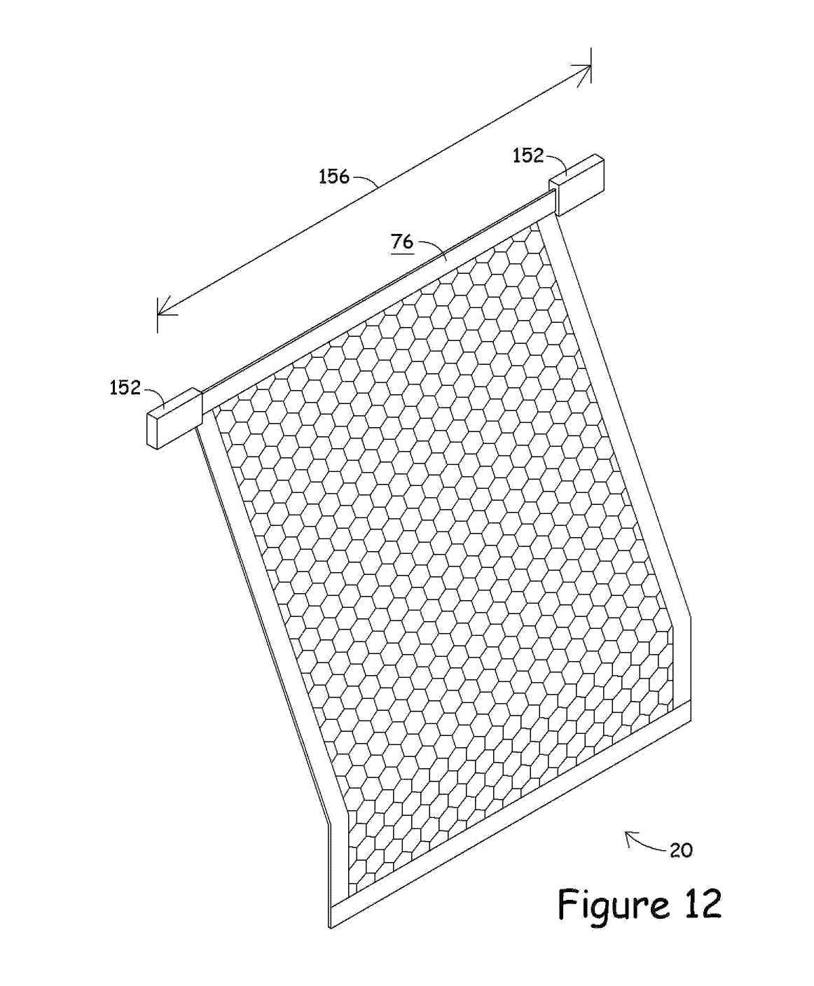

FIG. 10 depicts a slidable cap 152 which will be deployed in opposing pairs on insert 20. FIG. 11 depicts opening 154 of slidable cap 152 which will accept end 80 or 82 of extending portion 76. As shown in FIG. 12 and FIG. 13 slibable caps 152 may be positioned on extending portion 76 in any desired spacing between first spacing 156 and second spacing 158. This feature provides for retention of insert 20 in workpiece paint bucket 22 even if slightly deformed by the weight of workpiece paint 26.

With respect to the above description then, it is to be realized that the optimum dimensional relationships for the parts of the invention, to include variations in size, material, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An insert for deployment in a workpiece paint bucket, the insert to provide for rolling of a workpiece paint roller along the insert to generally uniformly distribute a workpiece paint previously gathered from the workpiece paint bucket onto the workpiece paint roller, the workpiece paint bucket having a workpiece paint containment area having an upper extent, a lower extent and a high operational paint capacity level, the high operational paint capacity level being a level to which workpiece paint is routinely placed in the workpiece paint bucket, the workpiece paint bucket having opposing anchoring portions, the insert comprising:
a) a paint roller contact area having a width and a height, the width of the paint roller contact area having opposing side edges, the height of the paint roller contact area extending substantially along the opposing side edges of the width of the paint roller contact area, the paint roller contact area having a primary portion and an auxiliary portion, the primary portion of the paint roller contact area having a dimensional size, the auxiliary portion of the paint roller contact area having a dimensional size, and wherein the dimensional size of the primary portion of the paint roller contact area is significantly greater than the dimensional size of the auxiliary portion of the paint roller contact area, the primary portion of the paint roller contact area positioned above the auxiliary portion of the paint roller contact area when the insert is deployed in the workpiece paint bucket, the insert oriented in the workpiece paint bucket during the deployment with the auxiliary portion of the paint roller contact area at least substantially below the high operational paint capacity level of the workpiece paint containment area of the workpiece paint bucket and with the primary portion of the paint roller contact area at least substantially above the high operational paint capacity level of the workpiece paint containment area of the workpiece paint bucket, the paint roller contact area for rolling the workpiece paint roller along to distribute the desired quantity of workpiece paint from the workpiece paint bucket onto the workpiece paint roller;
b) an extending portion extending beyond the width of the paint roller contact area on the opposing side edges of the width of the paint roller contact area, the extending portion to provide for engagement of the opposing anchoring portions of the workpiece paint bucket to secure the insert relative to the workpiece paint bucket, the extending portion having opposing ends;
c) width adjustment means to provide for adjustment of a spacing between the opposing ends of the extending portion wherein the insert will be securely contained within the workpiece paint bucket during use.

2. The insert defined in claim 1 wherein the width adjustment means further comprises opposing caps slidably positioned on the extending portion and containing the opposing ends of the extending portion.

3. The insert defined in claim 1 wherein the primary portion of the paint roller contact area further comprises a plurality of passageways therethrough.

4. The insert defined in claim 1 wherein the primary portion of the paint roller contact area has an angular orientation in the workpiece paint bucket which is significantly offset from vertical during deployment.

5. The insert defined in claim 1 wherein the auxiliary portion of the paint roller contact area has an angular orientation in the workpiece paint bucket which is substantially vertical during deployment.

6. The insert defined in claim 1 wherein the paint roller contact area further comprises a surrounding perimeter and wherein the insert further comprises a frame portion extending at least substantially around the surrounding perimeter of the paint roller contact area, the frame portion formed of a frame material folded over to engage and secure the paint roller contact area to provide for a strengthening of the structural integrity of the insert.

7. The insert defined in claim 1 wherein the insert further comprises lower securement means to provide for engagement of the workpiece paint bucket to further secure the insert relative to the workpiece paint bucket.

8. An insert for deployment in a workpiece paint bucket, the insert to provide for rolling of a workpiece paint roller along the insert to generally uniformly distribute a workpiece paint previously gathered from the workpiece paint bucket onto the workpiece paint roller, the workpiece paint bucket having a workpiece paint containment area having an upper extent and a lower extent, the workpiece paint bucket having opposing anchoring portions, the insert comprising:
a) a sheet material;
b) a frame assembly having an upper extent and a lower extent and opposing side extents, the frame assembly substantially defining a confined area, the frame assembly having securement means to provide for securing the sheet material within the confined area and wherein the upper extent further comprises opposing ends and wherein the opposing ends of the upper extent have spacing adjustment means to provide for adjustment of a spacing between the opposing ends of the upper extent wherein the insert will be securely contained within the workpiece paint bucket during use;
c) a paint roller contact area substantially formed from the sheet material within the confined area of the frame assembly and secured therein by the securement means of the frame assembly, the paint roller contact area having a width and a height, the width of the paint roller contact area having opposing side edges, the height of the paint roller contact area extending substantially along the opposing side edges of the width of the paint roller contact area, the paint roller contact area having a primary portion and an auxiliary portion, the paint roller contact area oriented in the workpiece paint bucket during the deployment with the auxiliary portion of the paint roller contact area generally inside the workpiece paint containment area of the workpiece paint bucket and the primary portion of the paint roller contact area positioned generally at the upper extent of the workpiece paint containment area of the workpiece paint bucket, the paint roller contact area for rolling the workpiece paint roller along the height of the paint roller contact area to distribute the desired quantity of workpiece paint from the workpiece paint bucket onto the workpiece paint roller; and wherein the upper extent of the frame assembly further comprises opposing protruding extensions each extending beyond the respective opposing side extent of the frame assembly, the opposing protruding extensions of the upper extent of the frame assembly to provide for engagement of the opposing anchoring portions of the workpiece paint bucket to secure the insert relative to the workpiece paint bucket.

9. The insert defined in claim 8 wherein the spacing adjustment means further comprises opposing caps slidably positioned on the opposing ends of the upper extent and containing the opposing ends of the upper extent.

10. The insert defined in claim 8 wherein the paint roller contact area is formed of a wire mesh material with a plurality of passageways therethrough.

11. The insert defined in claim 8 wherein the paint roller contact area is formed of a wire mesh material with a plurality of passageways therethrough and wherein each of the passageways is bordered by a perimeter having defined edges with each of the edges of the perimeter of each passageway angularly offset from vertical and from horizontal following deployment in the workpiece paint bucket.

12. The insert defined in claim 8 wherein the securement means of the frame assembly further comprises construction of the frame assembly from a planar material having a longitudinal length and a bending and folding of the planar material along the longitudinal length wherein the frame assembly retains the sheet material forming the paint roller contact area utilizing a pressure bearing pinching contact.

13. The insert defined in claim 8 wherein the workpiece paint bucket further has a lower anchoring portion positioned generally at the lower extent of the workpiece paint containment area, and wherein the insert further comprises lower securement means to provide for engagement of the lower anchoring portion of the workpiece paint bucket by portions of the frame assembly to further secure the insert relative to the workpiece paint bucket.

14. An insert for deployment in a workpiece paint bucket, the insert to provide for rolling of a workpiece paint roller along the insert to generally uniformly distribute a workpiece paint previously gathered from the workpiece paint bucket onto the workpiece paint roller, the workpiece paint bucket having a workpiece paint containment area having an upper extent and a lower extent, the workpiece paint bucket having opposing anchoring portions, the insert comprising:
a) an upper portion having a length and a width and a thickness, the length significantly greater than the width and the width significantly greater than the thickness, the upper portion further having an orientation plane extending at least substantially along the length and the width, the upper portion having securement means to provide for securing the insert in the workpiece paint bucket using the opposing anchoring portions of the workpiece paint bucket;
b) a paint roller contact area positioned below the upper portion when deployed in the workpiece paint bucket, the paint roller contact area having a width and a height, the paint roller contact area having an orientation plane extending at least substantially along the width and the height, the paint roller contact area for rolling the workpiece paint roller along the height of the paint roller contact area to distribute the desired quantity of workpiece paint from the workpiece paint bucket onto the workpiece paint roller;
c) an auxiliary portion positioned below the paint roller contact area when deployed in the workpiece paint bucket, the auxiliary portion having a width and a height, the auxiliary portion having an orientation plane extending at least substantially along the width and the height; and wherein the orientation plane of the upper portion is generally parallel to and offset from the orientation plane of the auxiliary portion while the orientation plane of the paint roller contact area is substantially offset relative to the orientation plane of the upper portion and to the orientation plane of the auxiliary portion;
d) opposing protrusions extending relative to the upper portion wherein the opposing protrusions each has an outer end;
e) spacing adjustment means to provide for adjustment of a spacing between the opposing outer ends of the opposing protrusions wherein the insert will be securely contained within the workpiece paint bucket during use.

15. The insert defined in claim 14 wherein the spacing adjustment means further comprises opposing caps slidably positioned on the opposing protrusions and containing the opposing outer ends of opposing protrusions.

16. The insert defined in claim 14 wherein the auxiliary portion of the insert further comprises lower securement means to provide for engagement of the workpiece paint bucket by portions of the auxiliary portion of the insert to further secure the insert relative to the workpiece paint bucket.

17. The insert defined in claim 14 wherein the paint roller contact area further comprises a plurality of passageways therethrough.

18. The insert defined in claim 14 wherein the paint roller contact area is at least partially formed of a wire mesh material with a plurality of passageways therethrough.

19. The insert defined in claim 14 wherein the paint roller contact area of the insert further comprises an upper extent and a lower extent when the insert is deployed in the workpiece paint bucket and wherein the orientation plane of the paint roller contact area is significantly offset relative to vertical when the insert is deployed in the workpiece paint bucket.
